(19) United States
(12) Patent Application Publication
(10) Pub. No.: US 2019/0185228 A1
(43) Pub. Date: Jun. 20, 2019

(54) CLOSURE ELEMENT WITH VENT OPENING

(71) Applicant: TECAN TRADING AG, Mannedorf (CH)

(72) Inventors: Harald Gebetsroither, Salzburg (AT); Manfred Lansing, Salzburg (AT); Markus Schurf, Bergen (DE)

(73) Assignee: TECAN TRADING AG, Mannedorf (CH)

(21) Appl. No.: 16/212,372

(22) Filed: Dec. 6, 2018

(30) Foreign Application Priority Data
Dec. 20, 2017 (EP) 17209048.2

(51) Int. Cl. B65D 51/16; G01N 21/11; G01N 21/03; B65D 51/24; B67C 3/22

(52) U.S. Cl. CPC B65D 51/16; G01N 21/11; B67C 3/222; B65D 51/242; G01N 21/03

(57) ABSTRACT

A closure element with at least one vent opening is a sealing plug that has a pin-shaped lower part with an underside. The at least one vent opening is formed by a duct in the sealing plug which, starting at an inlet opening into the duct, extends upwards from the underside of the pin-shaped lower part in the interior of the sealing plug and leads out of the sealing plug through a lateral outlet opening. A method is also disclosed for the complete and bubble-free filling of a container with a closure element and to the use of a filled container provided with a closure.

The present invention relates to a closure element having at least one vent opening. A closure element can be a stopper or a closure cap. This can be used, for example, to seal a container or a pipe end.

When filling a container with a liquid, it may be desirable or necessary to fill the liquid in such a way that no air residues or gas bubbles remain in the container after a closure element has been fitted.

DE 44 28 434 A1 proposes a closure cap for filling and closing containers without gas bubbles. This closure cap is designed in such a way that a part of the liquid content is displaced upwards out of the container by the form of an immersing displacement body closed towards the inside of the container during insertion through an annular gap between the displacement body and the container neck, so that gas and some liquid escape through one or more openings in the outside of the cap before the closure cap engages with a bead at the lower edge of the outside in a closure position on the container neck, and a seal at the upper edge of the container neck seals the interior.

DE 199 39 195 A1 describes a special cap for a bottle. It can be a screw cap or a plug-in cap, but especially a screw cap for a plastic bottle. Ambient air is usually present in the cavity of a closure cap which is open at the bottom before it is fitted. In the case of oxygen-sensitive beverages, it should be avoided that air from the closure cap enters a filled beverage bottle during sealing. In DE 199 39 195 A1 this problem is solved with a disc-shaped sealing element which also serves as a displacement element. Said element is positioned with its elastic edge area on the opening side of the outer wall of the closure cap before the closure cap is fitted. This prevents the air from the cavity of the cap from entering the bottle mouth when the cap is applied. On the other hand, during the closing process, the relative movement between the cap and the bottle mouth shifts the disc-shaped closure element into the cap, similar to a movable piston. It displaces the air in this case from the cavity of the closure cap to the outside through at least one discharge channel. The discharge channel may be a hole in the bottom or outer wall of the cap, or formed by interruptions in the raised threads of a screw cap. After completion of the closing process, the closure element fulfils the usual sealing function.

According to DE 198 33 435 A1, the contamination-free loading of a quartz cuvette with stoppers on both sides as a receptacle for the body fluid in a UV irradiation device for removed body fluids is difficult to handle. DE 198 33 435 A1 proposes to close one side of the receptacle tightly and to use a specially designed adapter plug on the loading and unloading side of the receptacle which, on the one hand, allows loading or unloading with a syringe through a bore in the adapter plug in a horizontal position and, on the other hand, allows pressure equalization, i.e. venting or ventilation of the gas chamber, through an additional ventilation bore in the adapter plug. The receptacle vessel used here is only partially loaded with the body fluid, so that there is always a gas space above the fluid. In addition, bubble-free filling plays no role here.

It is the object of the present invention to provide an alternative closure element with at least one vent opening.

This object is solved by a closure element with the features of claim 1.

The invention also comprises a container with such a closure element.

The present invention also relates to a method for the complete and bubble-free filling of a container with a closure element in accordance with the invention.

The use of a filled container fitted with a closure element in accordance with the invention is also part of the present invention.

Preferred embodiments and variants according to the invention result from the respective dependent claims.

According to the present invention, a closure element with at least one vent opening is a sealing plug which comprises a pin-shaped lower part with an underside, wherein the at least one vent opening is formed by a duct in the sealing plug which, starting at an inlet opening into the duct, extends upwards from the underside of the pin-shaped lower part in the interior of the sealing plug and leads out of the sealing plug through a lateral outlet opening. An equivalent term for the vent opening formed by the duct is the vent duct.

The shape and course of the vent duct can be arbitrary. For example, it can also extend eccentrically in the lower part. Alternatively, it could be bent or in the simplest case it could be an inclined hole from the underside out to the side. It could also be a combination of a rectilinear section and an arc. The lateral outlet opening can lead laterally out of the sealing plug at any distance from the underside.

The lateral outlet opening is the only outlet opening of the sealing plug in an embodiment of the closure element according to the invention. With this embodiment, the sealing plug has only one lateral outlet opening and no other open outlet opening or one that can be closed with a screw or a sealing body, for example.

In one embodiment of the closure element according to the invention, the duct in the sealing plug comprises two rectilinear sections, one of which runs centrically through the pin-shaped lower part and the other leads to the lateral outlet opening of the sealing plug.

In a preferred embodiment, the two rectilinear sections of the duct are aligned at right angles to each other.

In another preferred embodiment, the rectilinear section leading to the lateral outlet of the plug is obliquely aligned at an obtuse angle to the rectilinear centric section of the duct.

Preferably, the duct has an enlarged outlet cross-section at the lateral outlet opening. Such an enlarged outlet cross-section can serve as an expansion space for displaced liquid during fitting and after insertion of the closure element into a container opening.

On the underside of the pin-shaped lower part, the duct preferably has a bevel at the inlet opening. The bevel is preferably conical in shape, similar to a funnel. With this design of the inlet opening, air residues or gas bubbles can enter the vent duct more easily.

In the case of the closure element according to the invention, the pin-shaped lower part of the sealing plug can be round or rectangular in preferred embodiments. Round means particularly preferably circular, while rectangular also includes square.

In one embodiment of the closure element according to the invention, the sealing plug comprises a handle part integrally formed at the top on the pin-shaped lower part via an optional transition area. With such an embodiment, the lateral outlet opening preferably leads out of the handle section. The optional transition area can be a constriction or a cylindrical section, for example. Also in the transition area the lateral outlet opening could lead out in principle, or in the upper area of the pin-shaped lower part near the transition area. However, the handle part can also be molded directly onto the pin-shaped lower part without a transition area. In the simplest case, the shape of a directly formed handle part is an extension of the pin-shaped lower part. In the latter case, the plug as a whole would have the shape of a pin with a vent duct in accordance with the invention.

Various materials can be used for the closure element according to the invention, e.g. also a sealing plug made of cork having a vent duct according to the invention. However, the closure element according to the invention is preferably made of plastic, wherein PTFE (polytetrafluoroethylene) is particularly preferred as the plastic for the closure element.

In order to form the vent duct in a sealing plug in accordance with the invention, holes may have been drilled by subsequent machining. Other possible methods are, for example, production by 3D printing or laser sintering.

The invention also comprises a container with an interior space, which is delimited by a base and a side wall, and a container opening, wherein, in the case of a closure element (according to claim 1) inserted into the container opening and having a geometry of the pin-shaped lower part matching the container opening, there is a connection from the interior space of the container to the outside through the duct in the sealing plug.

The side wall of the container is an all-round side wall that runs all around. Depending on the layout of the base, the circumference of the side wall can be round, for example, or in the case of a rectangular floor, the side wall can consist of four corresponding partial walls.

The container opening is round or rectangular in preferred embodiments. Round means particularly preferably circular, while rectangular also includes square. A matching geometry of container opening and pin-shaped lower part of a sealing plug is, for example, a conical standard ground joint.

In a preferred embodiment, a closure element with a handle part is inserted into a container, wherein the lateral outlet opening leads out of the handle part and the handle part projects beyond the side wall of the container at the lateral outlet opening. With such an embodiment, the edge of the lateral outlet opening is located higher than the side wall of the container after horizontal placement with the lateral outlet opening in the handle part upwards. This is advantageous for venting gas bubbles during filling and also for collecting liquid displaced from the interior in the horizontal position of the container, without the liquid displaced into the vent duct overflowing directly. Due to a protruding liquid level in the vent duct, the interior of a filled and horizontally positioned container remains reliably filled with liquid by a slight overpressure through the liquid column without bubbles.

The container is preferably a cuvette. In the context of the present invention, a cuvette is preferably rectangular in cross-section, wherein rectangular also includes square.

A cuvette is preferably made of transparent plastic, glass or quartz glass. Rectangular standard cuvettes with a layer thickness of 10 mm (also called layer depth) are particularly preferred for liquids contained in the cuvette in the direction of a measuring beam through the transparent optical side surfaces.

The present invention also relates to a method for the complete and bubble-free filling of a container with a closure element, wherein first the container is largely filled with a liquid in a vertical position, and then a closure element with the features according to claim 1 is inserted, wherein air residues and a portion of the filled liquid are displaced and pushed up through the inlet opening into the duct starting at the underside of the pin-shaped lower part by the immersing pin-shaped lower part of the sealing plug, and finally the container is brought into a horizontal position so that the lateral outlet opening of the sealing plug points upwards with liquid standing in the duct.

The invention also includes the use of a filled container with a closure element in accordance with the invention for measurements in a horizontal position, wherein the container is preferably a cuvette. The container may preferably be filled in accordance with the method described in the previous paragraph.

Measurements in a horizontal position on cuvettes filled with sample liquids are preferably performed on an adapter in a microplate reader. A microplate reader (also called microplate reading device) is often used for the evaluation of biochemical or cell biological assays (sample examinations) and comprises a spectrometer for photometric measurements on mostly biological sample liquids in the depressions (wells) of microplates (also called microtiter plates). The present invention now allows measurements to be carried out with cuvettes in a microplate reader, if cuvettes filled without bubbles are placed horizontally on an adapter which has the layout dimensions of a standard microplate.

The measurements are preferably photometric measurements selected from a group of wavelengths and detection methods including UV, VIS, NIR, IR, fluorescence, luminescence and absorption.

In normal spectrophotometers, the problem of a complete and bubble-free filling of the cuvettes does not arise because the cuvettes are inserted vertically into the cuvette holder or sample shaft. Only the minimum filling height of the cuvettes must be observed so that the entire measuring beam passes through the liquid. If, on the other hand, the cuvettes have to be positioned horizontally for photometric measurements (as in the microplate reader mentioned above), air bubbles, which can hardly be avoided with conventional stoppers, drift from the upper part of the cuvette into the middle of the cuvette, similar to a spirit level, and falsify the measurements. Thanks to the present invention, this problem could be solved elegantly and surprisingly with the closure element according to the invention.

Another problem is also solved with the closure element according to the invention. If the sample liquid heats up during a longer measurement due to intensive light irradiation, the liquid expands, which can lead to overpressure and the ejection of a conventional stopper. If a closure element according to the invention is used, however, the liquid can expand through the duct in the sealing plug without increasing the pressure in the cuvette.

In the following, the invention is explained in more detail by means of schematic figures which represent exemplary embodiments which do not restrict the scope of the present invention, wherein:

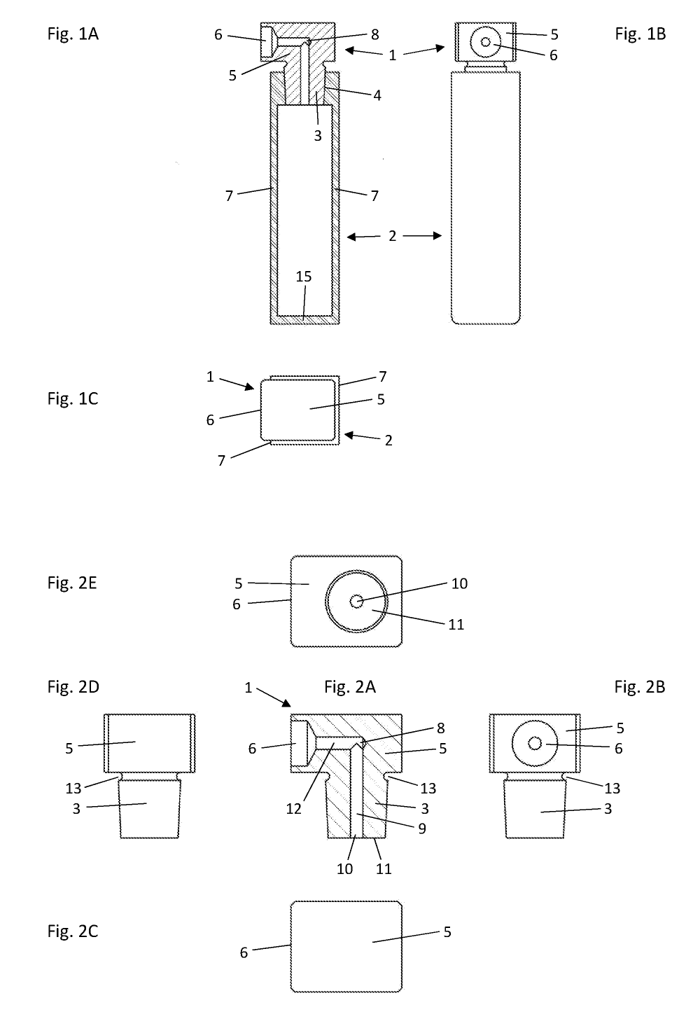

FIGS. 1A-1C show a closure element according to the invention inserted in a container in different views, namely:

FIG. 1A shows a longitudinal section through the container with inserted closure element in the plane of the vent duct;

FIG. 1B shows a side view of the container with the closure element inserted with a frontal view of the lateral outlet opening in the handle part of the sealing plug;

FIG. 1C shows a view from above of the container with the closure element inserted;

FIGS. 2A-E show a closure element according to the invention in different views, namely:

FIG. 2A shows a longitudinal section through the closure element in the plane of the vent duct;

FIG. 2B shows a side view of the closing element with a frontal view of the lateral outlet opening in the handle part of the closing plug;

FIG. 2C shows a top view of the closure element;

FIG. 2D shows a side view of the closure element from the opposite side of the outlet opening in the handle part;

FIG. 2E shows a view of the underside of the closure element;

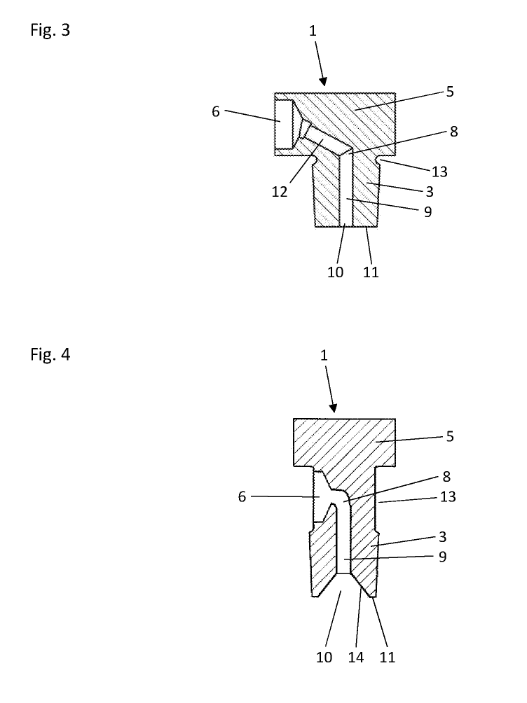

FIG. 3 shows a longitudinal section through another embodiment of a closure element according to the invention in the plane of the vent duct;

FIG. 4 shows a longitudinal section through a further embodiment of a closure element according to the invention in the plane of the vent duct.

FIGS. 1A-C schematically show a closure element 1 according to the invention inserted into a container 2, which is shown here standing vertically on its base 15. The closure element 1 shown here comprises a handle part 5. In the case shown, the container 2 represents a rectangular cuvette. The geometry of the pin-shaped lower part 3 of the closure element 1 matches the container opening 4 and is of conical shape in the example shown. In the partial FIGS. 1A and 1C, it can be seen as an advantageous embodiment that the handle part 5 with its lateral outlet opening 6 projects beyond the side wall 7 of the container 2. The other three sides of handle part 5 do not protrude beyond this, so that it is possible to place container 2 horizontally, in particular on the partial wall of side wall 7 which is opposite to the outlet opening 6 in handle part 5 when closure element 1 is inserted. In the partial FIGS. 1A and 1B, where the vent duct 8 leads into the lateral outlet opening 6, an area with an extended outlet cross-section is drawn. The latter serves as an expansion space for displaced liquid in the horizontal position of the container 2. Further details of the closure element 1 according to the invention are explained using FIGS. 2A-E.

FIGS. 2A-E show in the partial FIGS. 2A-E the closure element 1 according to the invention from FIGS. 1A-C again separately in different views. The views of FIGS. 2A, 2B and 2C correspond to the analog views of FIGS. 1A-C. In addition, FIGS. 2D and 2E show views of the closure element 1 from other viewing directions, as shown in the figure overview. FIG. 2A shows an embodiment of the closure element 1 according to the invention, in which the duct 8 in the sealing plug 1 comprises two rectilinear sections, of which one section 9, starting at the inlet opening 10 on the underside 11, runs centrically through the pin-shaped lower part 3, and the other section 12, leading to the lateral outlet opening 6 in the handle part 5, is aligned at a right angle thereto. At the point where it flows into the lateral outlet opening 6, duct 8 has an area with an extended outlet cross-section (as already mentioned in FIGS. 1A-C). The sealing plug 1 shown here has a transition area 13 between the pin-shaped lower part 3 and the handle part 5 integrally formed on top, here in the form of a constriction.

In a view comparable to FIG. 2A, FIG. 3 shows another advantageous embodiment of a closure element 1 in which the rectilinear section 12 of duct 8 leading to the lateral outlet opening 6 of handle part 5 is aligned obliquely at an obtuse angle to the rectilinear central section 9 of duct 8. Such an oblique hole may prevent small gas bubbles from getting stuck at the angle of the two rectilinear sections of duct 8 which meet. Here, too, it is preferred, as shown, if the duct 8, where it opens into the lateral outlet opening 6, has an area with an extended outlet cross-section. The sealing plug 1 shown in FIG. 3 also has a transition area 13 in the form of a constriction between the cone-shaped lower part 3 and the handle part 5 integrally formed on top.

FIG. 4 shows a different embodiment of a closure element 1 to illustrate further possible embodiments of individual features. In this embodiment of a sealing plug 1, there is a transition area 13 in the form of a cylindrical neck between the pin-shaped lower part 3 and the handle part 5 integrally formed on top. The lateral outlet opening 6 leads out of this neck. The vent duct 8 shown here has a centric rectilinear section 9 through the pin-shaped lower part 3, and a curved shape in the section towards the lateral outlet opening 6. A further detail can be seen in FIG. 4 on the underside 11 of the cone-shaped lower part 3: Here, duct 8 has a bevel 14 at the inlet opening 10. The shown bevel has a conical shape like a funnel. Air residues or gas bubbles can enter and escape upwards more easily into an inlet opening designed in this way.

A beveling of the entrance opening can be applied to all embodiments of a closure element according to the invention and is not tied to the embodiment shown in FIG. 4.

At this point it should be noted that any combination of the features described and/or shown in the figures is part of the scope of the present invention as long as the combinations are not inconsistent.

As can be seen from the description and explanations of the figures, this invention provides a versatile solution with several advantages.

### LIST OF REFERENCE NUMERALS

The same reference numerals in the figures indicate corresponding features, even if the description of the individual figures does not always refer to them explicitly.

1 Closure element, sealing plug

### 2 Container

3 Pin-shaped lower part of the closure element
4 Container opening
5 Handle part of the sealing plug
6 Lateral outlet opening from the sealing plug
7 Side wall of the container
8 Duct, vent duct
9 Centric rectilinear section of the duct
10 Inlet opening into the duct
11 Underside of the pin-shaped lower part
12 Rectilinear section of the duct leading to the lateral opening of the sealing plug
13 Transition area of the sealing plug
14 Beveling of the inlet opening
15 Base of the container

1. Closure element having at least one vent opening, characterized in that the closure element is a sealing plug which comprises a pin-shaped lower part with an underside, wherein the at least one vent opening is formed by a duct in the sealing plug which, starting at an inlet opening into the duct, extends upwards from the underside of the pin-shaped lower part in the interior of the sealing plug and leads out of the sealing plug through a lateral outlet opening.

2. Closure element according to claim 1, characterized in that the lateral outlet opening is the only outlet opening of the sealing plug.

3. Closure element according to claim 1, characterized in that the duct in the sealing plug comprises two rectilinear sections, one of which runs centrically through the pin-shaped lower part and the other leads to the lateral outlet opening of the sealing plug.

4. Closure element according to claim 3, characterized in that the two rectilinear sections of the duct are aligned at right angles to one another.

5. Closure element according to claim 3, characterized in that the rectilinear section leading to the lateral outlet opening of the sealing plug is oriented obliquely at an obtuse angle to the rectilinear centric section of the duct.

6. Closure element according to claim 1, characterized in that the duct has an enlarged outlet cross-section at the lateral outlet opening.

7. Closure element according to claim 1, characterized in that the duct has a bevel at the inlet opening on the underside of the pin-shaped lower part.

8. Closure element according to claim 1, characterized in that the pin-shaped lower part of the sealing plug is round or rectangular.

9. Closure element according to claim 1, characterized in that the sealing plug comprises a handle part integrally formed at the top on the pin-shaped lower part via an optional transition region, wherein the lateral outlet opening preferably leads out of the handle part.

10. Closure element according to claim 1, characterized in that the closure element is formed from plastic, wherein PTFE is preferred as the plastic.

11. Container having an interior space, which is delimited by a base and a side wall, and having a container opening, characterized in that in a closure element inserted into the container opening according to claim 1 having a geometry of the pin-shaped lower part matching the container opening, there is a connection from the interior space of the container to the outside through the duct in the sealing plug.

12. Container according to claim 11, characterized in that the container opening is round or rectangular.

13. Container according to claim 11, characterized in that a closure element with a handle part is inserted, wherein the lateral outlet opening leads out of the handle part and the handle part projects beyond the side wall of the container at the lateral outlet opening.

14. Container according to claim 11, characterized in that the container is a cuvette, wherein the cuvette is preferably rectangular in the cross-section thereof.

15. Container according to claim 14, characterized in that the cuvette is made of transparent plastic, glass or quartz glass.

16. Method for the complete and bubble-free filling of a container with a closure element, characterized in that first the container is largely filled with a liquid in the vertical position, that a closure element according to claim 1 is then inserted, wherein air residues and a portion of the filled liquid are displaced and pushed up through the inlet opening into the duct starting at the underside of the pin-shaped lower part by the immersing pin-shaped lower part of the sealing plug, and finally the container is brought into a horizontal position so that the lateral outlet opening of the sealing plug faces upwards with liquid standing in the duct.

17. Use of a filled container with a closure element according to claim 1 for measurements in a horizontal position, wherein the container is preferably a cuvette.

18. Use according to claim 17, characterized in that the measurements are carried out in a horizontal position on cuvettes filled with sample liquids on an adapter in a microplate reader.

19. Use according to claim 18, characterized in that the measurements are photometric measurements selected from a group of wavelengths and detection methods comprising UV, VIS, NIR, IR, fluorescence, luminescence and absorption.
